(19) United States
(12) Patent Application Publication
(10) Pub. No.: US 2003/0218376 A1
(43) Pub. Date: Nov. 27, 2003

(54) Brake shifting device for controlling front brake system and rear brake system

(76) Inventors: Sen-Yung Lee, Tainan City (TW); Chung-Shun Su, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/151,146

(22) Filed: May 21, 2002

(51) Int. Cl. B60T 13/00

(52) U.S. Cl. 303/9.64; 303/9.65

(57) ABSTRACT

A hydraulic control device for controlling brake systems includes a base having two first passages defined therethrough so as to define two first inlets and two outlets. A second passage is connected between the two first passages and communicates with the two first passages. A shaft is rotatably inserted in the base has a third passage defined therethrough which communicates with the second passage by rotating the shaft. Two first hoses are respectively connected to the two first inlets and the two brake levers. Each first hose has a hydraulic liquid reservoirs connected thereto. Two second hoses are respectively connected to the two outlets and the two brake systems. The front brake system and the rear brake system are operated simultaneously by pulling either one of the brake levers.

### FIELD OF THE INVENTION

The present invention relates to a hydraulic control device for controlling front brake system and rear brake system of bicycles or motorbikes.

### BACKGROUND OF THE INVENTION

A conventional brake system for bicycles or motorbikes generally includes a front brake system for braking the front wheel and a rear brake system for braking the rear wheel. The front brake system is activated by a brake lever usually on the right hand grip and the rear brake system is activated by a brake lever on the left hand grip. The two brake systems are independent with each other so that the rider decides which brake system is to be activated or both of the two brake systems are to be activated. Generally, the brake pads of the rear brake system is worn much than that of the front brake system that is because the rear brake system is often used to stop or slow down the bicycle or motorbike. When going downward at a hill, in order to effectively stop the bicycle or motorbike, the two brake levers will be used. Because the rear brake pads usually are thinner than the front brake pads so that when the two brake levers are simultaneously pulled, the front brake pads stop the front wheel slightly earlier than the step of the rear wheel. This could result in a dangerous flip-flap.

The present invention intends to provide a hydraulic control device which adjusts the hydraulic liquid to activate the two brake systems when either one of the two brake levers is pulled.

### SUMMARY OF THE INVENTION

In accordance with one aspect of the present invention, there is provided a hydraulic control device for controlling brake systems and the device comprises a base having two first passages so as to define two first inlets and two outlets in an outside of the base. A second passage is connected between the two first passages and communicates with the two first passages. A shaft is rotatably inserted in the base and has a third passage located in communication with the second passage by rotating the shaft.

Two first hoses connected to two brake levers are respectively connected to the two first inlets and each first hose has a hydraulic liquid reservoirs connected thereto. Two second hoses connected to two brake systems are respectively connected to the two outlets.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the hydraulic control device for controlling brake systems of the present invention;

FIG. 2 shows the passages of the base of the hydraulic control device for controlling brake systems of the present invention;

FIG. 3 shows the passages of the base of the hydraulic control device for controlling brake systems of the present invention wherein the shaft is rotated so cut off the communication between the first passages and the second passage;

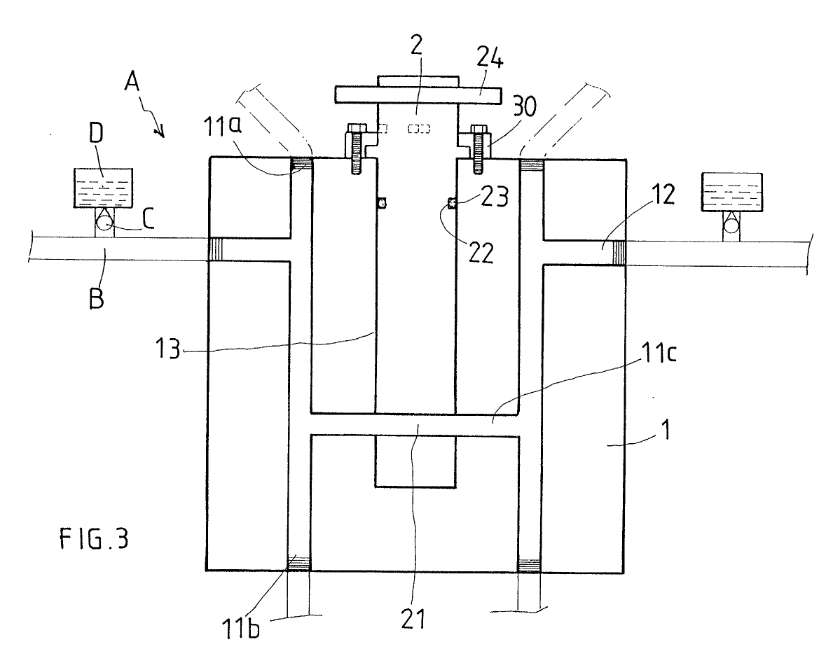

FIG. 4 shows the connection of the hoses of the base and the brake systems of a motor bike, and

FIG. 5 shows the other way of connection of the hoses of the base and the brake systems of a motor bike.

### DETAILED DESCRIPTION OF THE PREFERRED EMBODIMENT

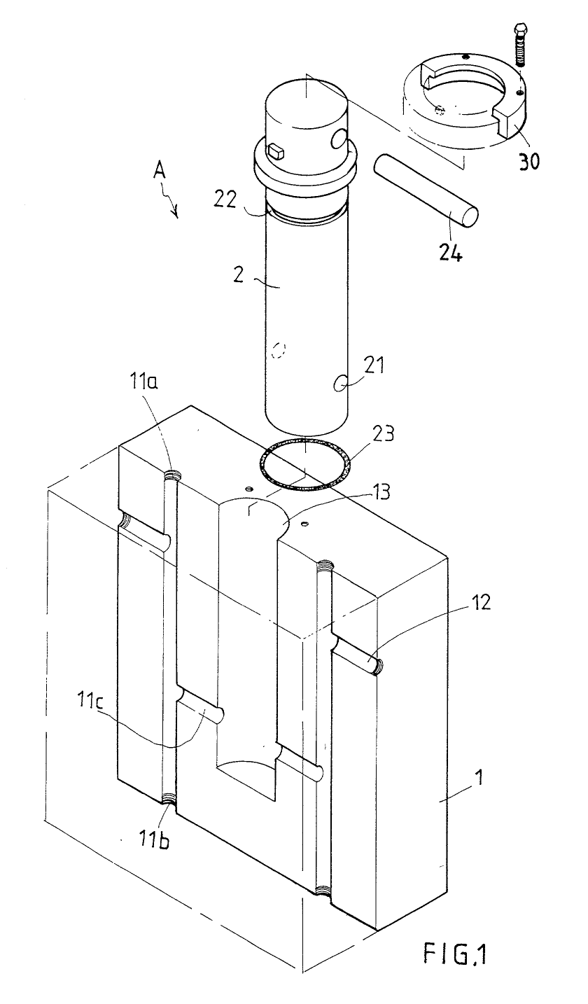

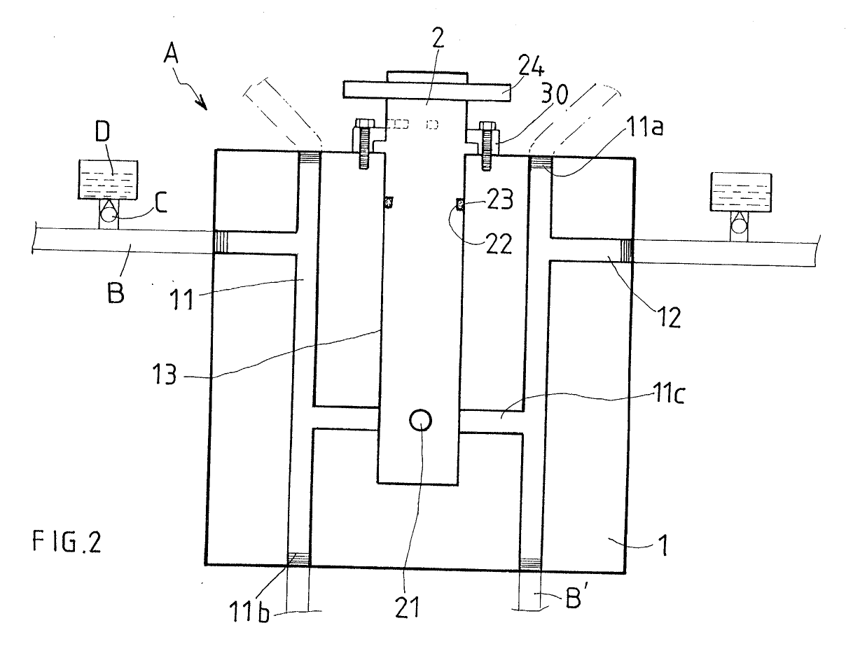

Referring to FIGS. 1 and 2, the hydraulic control device A for controlling brake systems of the present invention comprises a base 1 which can be connected to a proper position on the frame of a bicycle or motor bike so that the rider is able to conveniently operate. The base 1 has two first passages 11 defined therethrough so as to define two first inlets 11a on the top of the base 1 and two outlets 11b in an underside of the base 1. A second passage 11C is connected between the two first passages 11 and communicates with the two first passages 11. Two fourth passages 12 are defined in the base 1 and communicate with the two first passages 11 respectively.

A shaft 2 is rotatably inserted in a cylindrical recess 13 in the base 1 and has a third passage 21 defined therethrough. The third passage 21 is located in communication with the second passage 11C when the shaft 2 is rotated to a specific angle as shown in FIG. 2. A groove 22 is defined in an outer surface of the shaft 2 and a seal 23 is engaged with the groove 22 so as to prevent hydraulic liquid from leakage. A collar 30 is mounted to an end of the shaft 2 extending from the base 1 and fixed on the base 1. The shaft 2 rotatably extends through the collar 30 and an operation pin 24 radially extends through the end extending from the base 1 so that the shaft 2 can be conveniently rotated by operating the operation pin 24.

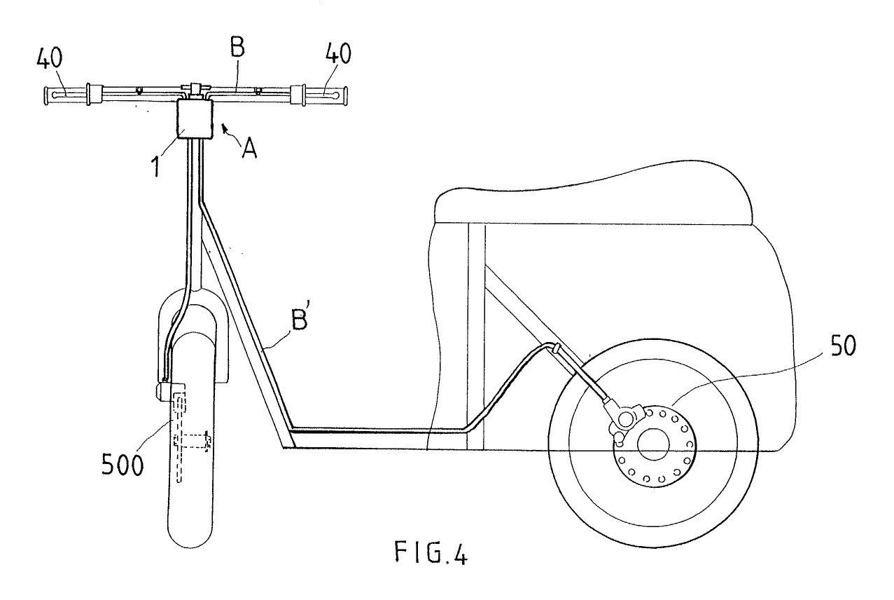

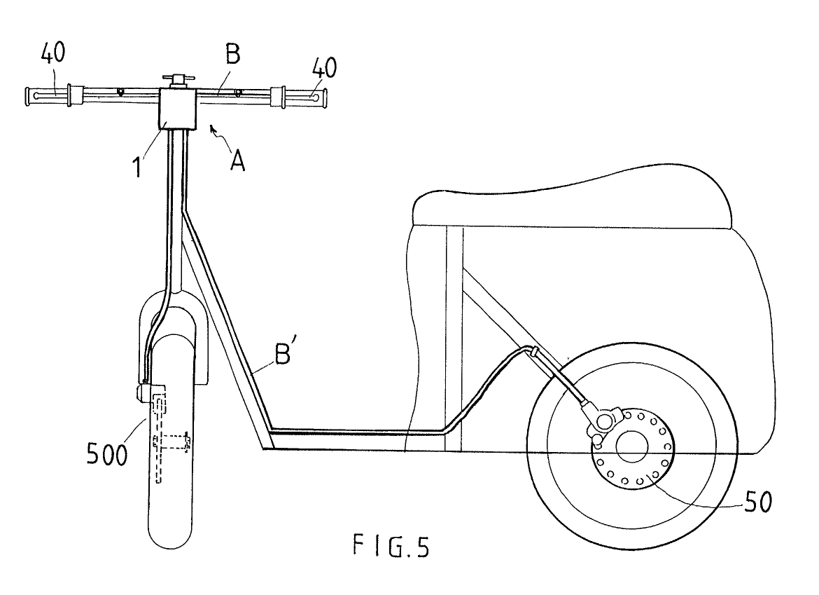

Two first hoses B are respectively connected between the two first inlets 11a as shown in FIG. 4 or the two fourth inlets 12 as shown in FIG. 5 and the two brake levers 40 as shown in FIG. 4. It is to be noted that when the two first hoses B are connected to the two first inlets 11a, the two fourth inlets 12 are sealed, vice versa. Each first hose B has a hydraulic liquid reservoirs D connected thereto and each hydraulic liquid reservoirs D has a one-way valve C. The hydraulic liquid reservoirs D ensures the hydraulic liquid is sufficiently supplied. Two second hoses B′ are respectively connected to the two outlets 11b and the two brake systems 50, 500.

Because the second passage 11C communicates with the two first passages 11 so that either one of the brake levers 40 are pulled, the hydraulic liquid activates the two brake systems 50, 500 simultaneously. The brake power of the two brake systems 50, 500 can be adjusted according to the needs by rotating the shaft 2 to set how many percentages of the third passage 21 to be communicate with the second passage 11C.

While we have shown and described the embodiment in accordance with the present invention, it should be clear to those skilled in the art that further embodiments may be made without departing from the scope of the present invention.

What is claimed is:

1. A hydraulic control device for controlling brake systems, comprising:
a base having two first passages defined therethrough so as to define two first inlets and two outlets in an outside of the base, a second passage connected between the two first passages and communicating with the two first passages;
a shaft rotatably inserted in the base and having a third passage defined therethrough, the third passage communicating with the second passage by rotating the shaft, and
two first hoses respectively connected to the two first inlets and being adapted to be connected to two brake levers, each first hose having a hydraulic liquid reservoirs connected thereto, two second hoses respectively connected to the two outlets and being adapted to be connected to two brake systems.

2. The device as claimed in claim 1 further comprising two fourth passages defined in the base and communicating with the two first passages respectively.

3. The device as claimed in claim 1 further comprising a collar mounted to an end of the shaft extending from the base and fixed on the base, the shaft rotatably extending through the collar.

4. The device as claimed in claim 1 further comprising an operation pin radially extending through an end extending from the base.
